(19) United States
(12) Patent Application Publication
(10) Pub. No.: US 2017/0241591 A1
(43) Pub. Date: Aug. 24, 2017

(54) HIGH-PRESSURE TANK AND METHOD OF MANUFACTURING HIGH-PRESSURE TANK

(71) Applicant: TOYOTA JIDOSHA KABUSHIKI KAISHA, Toyota-shi (JP)

(72) Inventors: Shiro NISHIBU, Nisshin-shi (JP); Motoki MAEKAWA, Toyota-shi (JP)

(73) Assignee: TOYOTA JIDOSHA KABUSHIKI KAISHA, Toyota-shi (JP)

(21) Appl. No.: 15/434,392

(22) Filed: Feb. 16, 2017

(30) Foreign Application Priority Data
Feb. 18, 2016 (JP) 2016-029136
Nov. 8, 2016 (JP) 2016-218459

(51) Int. Cl. F17C 1/06; B29C 70/32

(52) U.S. Cl. CPC F17C 1/06; B29C 70/32; F17C 2201/0109; F17C 2203/0604; F17C 2203/067; F17C 2270/0184; F17C 2260/011; F17C 2209/2154; B29L 2031/712

(57) ABSTRACT

A high-pressure tank which is capable of improving the strength of a connecting part between a cylindrical part and a dome part is provided. A high-pressure tank 10 according to the present invention comprises: a liner 20 having a cylindrically-shaped cylindrical part 20a and hemispherically-shaped dome parts 20b which are continuous with both ends of the cylindrical part 20a; and a reinforcing layer 30 including a fiber bundle which is hoop-wound around the cylindrical part 20a of the liner 20 and a fiber bundle which is helically wound around the dome parts 20b thereof. An outer diameter of the end of the cylindrical part 20a is smaller than an outer diameter of a portion of the cylindrical part 20a which excludes the end.

### TECHNICAL FIELD

The present invention relates to a high-pressure tank and a method of manufacturing a high-pressure tank.

### BACKGROUND ART

In recent years, developments have been made regarding a vehicle equipped with a fuel cell which is supplied with a fuel gas and an oxidant gas, being reaction gases, and which generates electric power via an electrochemical reaction of such reaction gases. This vehicle is often equipped with a high-pressure tank which stores a fuel gas (natural gas, hydrogen, etc.). As the high-pressure tank provided in this vehicle, a high-pressure tank is used in which an outer surface thereof, being served by a liner made of resin, is covered with a reinforcing layer made of fiber reinforced plastics (FRP) (hereinafter referred to as a fiber reinforced plastics layer).

The aforementioned fiber reinforced plastics layer is formed by winding fibers impregnated with a thermosetting resin around a liner by a filament winding method. In general, hoop winding is mainly employed for fiber winding to be performed on a cylindrically-shaped body part (cylindrical part) of a liner made of resin, and helical winding is mainly employed for fiber winding to be performed on spherically-shaped hemispherical parts (dome parts) which are provided at both ends of the body part (see, for example, Patent Document 1 below).

### PRIOR ART REFERENCE

### Patent Document

Patent Document 1: JP5621631 B

### SUMMARY OF THE INVENTION

### Problem to be Solved by the Invention

The number of hoop winding layers may be smaller in a connecting part between a cylindrical part and a dome part than in the cylindrical part, in order to prevent a step from being generated in such connecting part. Such situation has carried the risk of the connecting part having insufficient strength. Further, it has been necessary to secure the strength of the cylindrical part while ensuring the strength of the connecting part.

The present invention has been made in light of the above problem, and an object of the present invention is to provide a high-pressure tank which is capable of improving the strength of a connecting part between a cylindrical part and a dome part. Another object of the present invention is to provide a method of manufacturing a high-pressure tank which is capable of improving the strength of a cylindrical part.

### Means for Solving the Problem

In order to solve the above problem, the high-pressure tank according to the present invention is a high-pressure tank comprising: a liner; and a reinforcing layer of fiber bundles would around the liner, wherein: the liner comprises a cylindrically-shaped cylindrical part and a hemispherically-shaped dome part which is continuous with an end of the cylindrical part; the reinforcing layer includes a fiber bundle which is hoop-wound around the cylindrical part of the liner and a fiber bundle which is helically wound around the dome part thereof; and an outer diameter of the end of the cylindrical part is smaller than an outer diameter of a portion of the cylindrical part which excludes the end.

With such configuration, since the outer diameter of the end of the cylindrical part is smaller than the outer diameter of the portion of the cylindrical part which excludes the end, the number of layers (the number of hoop winding layers) which constitute the wound reinforcing layer can be increased at the end thereof. Thus, the reinforcing layer can be made thicker at the end thereof compared with the case of a conventional configuration (a configuration of a liner comprising a cylindrical part having a uniform outer diameter), and therefore, the strength of the end, that is, the strength of a connecting part between the cylindrical part and the dome part, can be improved.

In the high-pressure tank according to the present invention, the end may have a tapered part whose outer diameter decreases from an axial center of the cylindrical part toward the dome part.

In the high-pressure tank according to the present invention, the tapered part may have an inclination angle of from 5 to 10° relative to an axial center line of the cylindrical part.

Further, the method of manufacturing a high-pressure tank according to the present invention is a method of manufacturing a high-pressure tank comprising a liner, being an inner shell, which has a cylindrically-shaped cylindrical part and a hemispherically-shaped dome part which is continuous with an end of the cylindrical part, wherein, as to a liner or a fiber-bundle wound liner in which an outer diameter of the end is smaller than an outer diameter of a portion of the cylindrical part which excludes the end, a fiber bundle is helically wound around the liner so as to follow a geodesic trajectory on the dome part.

When winding a fiber bundle along a geodesic trajectory, as an end of a cylindrical part of a liner has a smaller radius, the angle at which the fiber bundle is arranged in the cylindrical part becomes larger. Under the premise that a helical layer which involves a large arrangement angle in the cylindrical part has a larger value of conversion to hoop layers (in terms of the number of hoop layers) than a helical layer which involves a small arrangement angle, as helical winding is performed at a larger arrangement angle in the cylindrical part, the value in terms of the number of hoop layers in the cylindrical part will further be increased. By increasing the value in terms of the number of hoop layers in the cylindrical part in this way, the strength of the cylindrical part can be improved.

### Effect of the Invention

The present invention can provide a high-pressure tank which is capable of improving the strength of a connecting part between a cylindrical part of a liner and a dome part thereof. The present invention can also provide a method of manufacturing a high-pressure tank which is capable of improving the strength of a cylindrical part.

### BRIEF DESCRIPTION OF THE DRAWINGS

FIG. 1 is a cross-sectional view showing a schematic configuration of a high-pressure tank which serves as an embodiment of the present invention.

FIG. 2 is a main-part cross-sectional view, being an enlarged view of a connecting part between a cylindrical part and a dome part, and a peripheral part of the connecting part.

FIG. 3A is a view for explaining a method of manufacturing a high-pressure tank, and FIG. 3B is a view as seen from an A direction in FIG. 3A.

FIG. 4 is a graph showing the relationship between an arrangement angle in a cylindrical part and a value of conversion to hoop layers.

### BEST MODE FOR CARRYING OUT THE INVENTION

Embodiments of the present invention will hereinafter be described with reference to the attached drawings. It should be noted that the descriptions set forth below concerning preferred embodiments are provided for illustrative purposes only and are not intended to limit the present invention, the applications or the uses.

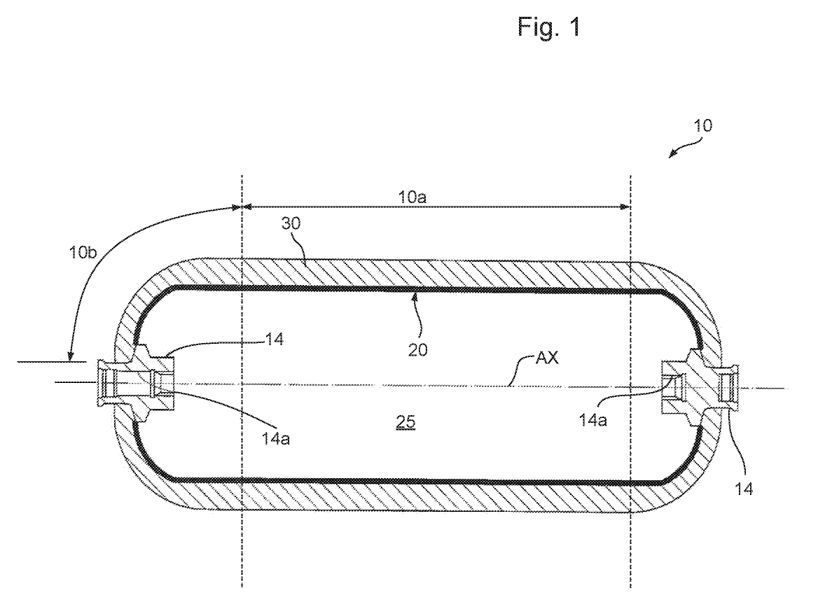

Firstly, a configuration of a high-pressure tank will be described. FIG. 1 is an explanatory view showing a schematic configuration of a high-pressure tank 10 which serves as an embodiment of the present invention.

As shown in FIG. 1, the high-pressure tank 10 is configured to comprise a body part 10a and hemispherical parts 10b provided at both ends of the body part 10a. The body part 10a and the hemispherical parts 10b are constituted by: a liner (barrier layer) 20 which defines a storage space 25 for a fuel gas (hydrogen, etc.) and which prevents a hydrogen gas from flowing out of the storage space 25; and a reinforcing layer 30 which is arranged on the outer side of the liner 20.

The body part 10a is a substantially cylindrical portion which extends for a predetermined length in the direction of an axis AX of the high-pressure tank 10, i.e., in the longitudinal direction thereof. Meanwhile, the hemispherical parts 10b are hemispherically-shaped curved wall parts which are respectively continuous with both the ends, in the longitudinal direction, of the body part 10a. The diameter of the hemispherical part 10b decreases as it becomes more distant from the body part 10a. An opening 14a is formed in the center of a portion of the hemispherical part 10b which has the most reduced diameter, and the opening 14a is provided with a mouthpiece 14.

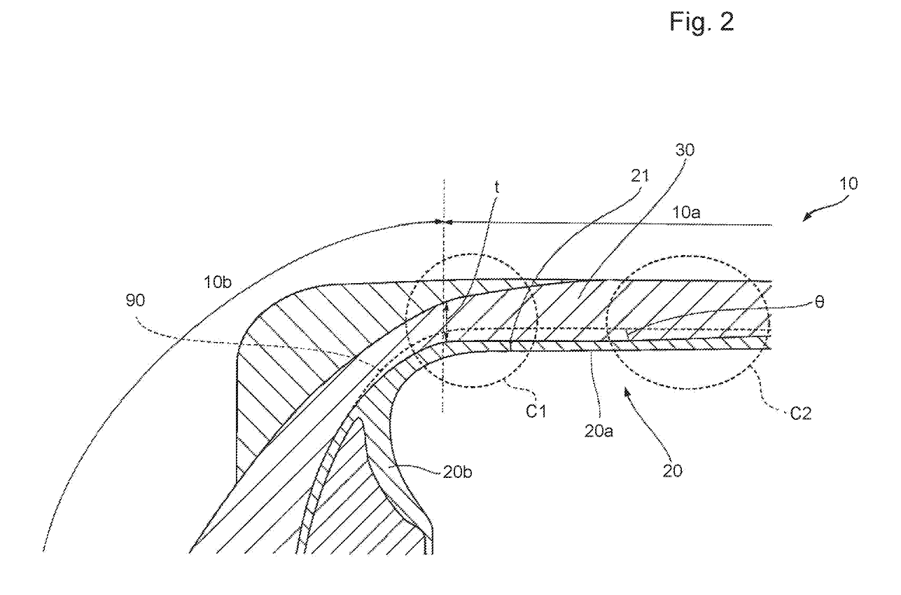

The liner 20 is a portion which is also referred to as an inner shell or inner container of the high-pressure tank 10, and the liner 20 stores a fuel gas (hydrogen gas) therein. The liner 20 constitutes inner walls of the body part 10a and of the hemispherical parts 10b. The liner 20 comprises a cylindrically-shaped body part (hereinafter referred to as a cylindrical part 20) and hemispherical parts (hereinafter referred to as dome parts 20b) provided continuously with both ends of the cylindrical part 20a. In the present embodiment, a boundary between the cylindrical part 20a and the dome part 20b, and a peripheral part thereof, are collectively referred to as a connecting part C1 (see FIG. 2). Preferred materials for the liner 20 include a polyethylene resin, a polypropylene resin and other hard resins from the viewpoint of attempting weight reduction.

An example of a method of manufacturing a liner 20 is a method comprising the steps of: molding, via extrusion molding, etc., a cylindrically-shaped cylindrical part 20 being provided with opened ends; molding, via injection molding, etc., hemispherically-shaped dome parts 20b; and joining the obtained the cylindrical part 20a and dome parts 20b via heat welding.

The reinforcing layer 30 is a portion which is also referred to as an outer shell or outer container of the high-pressure tank 10, and the reinforcing layer 30 constitutes outer walls of the body part 10a and of the hemispherical parts 10b. The reinforcing layer 30 is formed by being wound about the liner 20 so as to cover an outer surface of the liner 20, and comprises a fiber bundle mainly hoop-wound around the cylindrical part 20a of the liner 20 and a fiber bundle mainly helically wound around the dome part 20b of the liner 20. Examples of materials for the reinforcing layer 30 include an epoxy resin, and it is preferable to use a thermosetting resin.

For both hoop winding and helical winding, a filament winding method (FW method) is used by way of example.

Subsequently, a configuration of the connecting part C1 (entrance-to-dome part), which is provided between the body part 10a and the hemispherical part 10b, and a peripheral part thereof, will be described. FIG. 2 is a main-part cross-sectional view, being an enlarged view of the connecting part C1 and a peripheral part thereof in the high-pressure tank 10.

In the high-pressure tank 10 in the present embodiment, in an area of the liner 20 which is located forward of the dome part 20b, an outer diameter of the connecting part C1 in the liner 20 (a diameter of an outer peripheral surface 21 of the liner 20 in the connecting part C1) is made smaller than an outer diameter of a portion of the cylindrical part 20a which excludes the connecting part C1. More specifically, as shown in FIG. 2, an area of the liner 20 (a stepped part C2) which is located forward of the connecting part C1 is tapered, whereby the outer diameter of the connecting part C1 is made smaller than the outer diameter of the portion of the cylindrical part 20a which excludes the connecting part C1. That is, the end of the cylindrical part 20a has a tapered part whose outer diameter decreases from an axial center of the cylindrical part 20a toward the dome part 20b. In other words, the outer diameters of the connecting part C1 and its peripheral part are each made smaller than a diameter of an outer peripheral surface of a liner 90 (the broken line in FIG. 2) in the case of employing a liner comprising a body part (cylindrical part) having a uniform outer diameter.

As described above, by making the outer diameter of the end of the cylindrical part 20a smaller than the outer diameter of the portion of the cylindrical part 20a which excludes the end, the number of layers (the number of hoop winding layers) which constitute the reinforcing layer 30 wound around the end of the cylindrical part 20a can be increased. Thus, a thickness t of the reinforcing layer 30 at the end of the cylindrical part 20a, i.e., at the connecting part C1 and its peripheral part can be made larger than in a conventional configuration (a configuration of a liner comprising a cylindrical part having a uniform outer diameter). As a result, the strength of the connecting part C1 and its peripheral part can be improved. Further, as to the end of the cylindrical part 20a, if, for example, a stepped shape is employed therefor, large strains are generated in the fiber bundle wound around the liner. However, as described above, the end of the cylindrical part 20a has a tapered part whose outer diameter decreases from the axial center of the cylindrical part 20a toward the dome part 20b, and this can suppress the generation of strains in the fiber bundle.

The thickness t of the reinforcing layer 30 at the connecting part C1 is preferably set within, for example, a range of from 20 to 30 mm, in order to attain a strength equal to or greater than a required strength for the connecting part C1, i.e., in order to satisfy the relationship of (thickness t)≧(required strength for the entrance-to-dome part).

A taper angle in the stepped part C2 is preferably set within, for example, a range of from 5 to 10° in order avoid easily causing the occurrence of slippage of the reinforcing layer 30 which covers the outer surface of the liner 20. In other words, in order to avoid easily causing the occurrence of slippage of the reinforcing layer 30 which covers the outer surface of the liner 20, the tapered part whose outer diameter decreases from the axial center of the cylindrical part 20a toward the dome part 20b preferably has an inclination angle of from 5 to 10° relative to an axial center line (the central axis AX shown in FIG. 1) of the cylindrical part 20a. The length of tapering is preferably set within, for example, a range of from 30 to 60 mm from the viewpoint of suppressing a reduction in the amount of loading of the hydrogen stored in the liner 20 and also from the viewpoint of avoiding the generation of stress concentrations in the liner 20 and the reinforcing layer 30.

In the above-described high-pressure tank 10 according to the present embodiment, the liner 20 comprises the cylindrically-shaped cylindrical part 20a and the hemispherically-shaped dome parts 20b which are continuous with both the ends of the cylindrical part 20a, the reinforcing layer 30 includes the fiber bundle hoop-wound around the cylindrical part 20a of the liner 20 and the fiber bundle helically wound around the dome part 20b, and the outer diameter of the end of the cylindrical part 20a is smaller than the outer diameter of the portion of the cylindrical part 20a which excludes the end. Thus, by making the outer diameter of the end of the cylindrical part 20a small, the number of layers hoop-wound around the connecting part C1 and its peripheral part can be increased, whereby the strength of the connecting part C1 and its peripheral part can be improved.

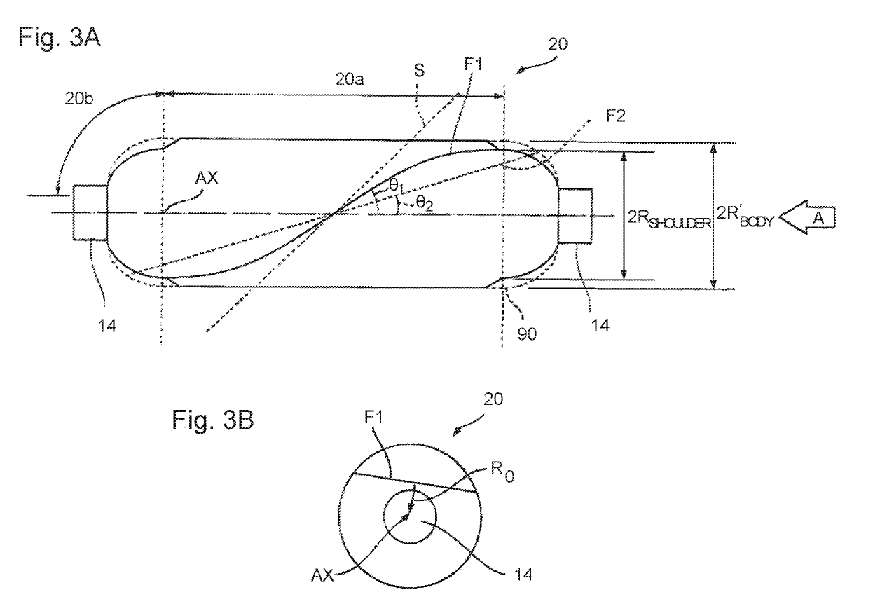

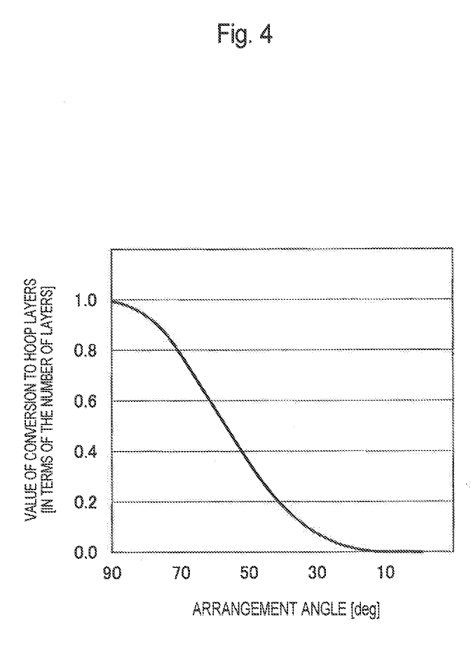

Next, a high-pressure tank manufacturing method according to the present embodiment will be described. FIG. 3A is a view for explaining a method of manufacturing a high-pressure tank. FIG. 3B is a view as seen from an A direction in FIG. 3A and is an explanatory view showing a fiber bundle around the liner 20 at a predetermined distance from the central axis of the high-pressure tank. FIG. 4 is a graph showing the relationship between an arrangement angle and a value of conversion to a hoop layer.

In the FW method, when attempting to arrange fibers, in a dome part, so as to pass a position at a distance from a mouthpiece, an arrangement angle needs to be set such that the fibers follow a geodesic trajectory in order to suppress the side slipping of the fibers in a shoulder part (a curved part closer to the boundary between the dome part and a cylindrical part). In such case, the direction of fibers deviates greatly from the principal stress direction in the cylindrical part, and thus, the amount of fibers required to secure the strength of the cylindrical part is increased. In order to mitigate such increase, a winding method is employed in which a shift is made continuously from helical winding for the dome part to hoop winding for the cylindrical part by gradually increasing, in the cylindrical part, the arrangement angle of the fibers which have passed near a geodesic line.

However, the above method has the problem set forth below, wherein helical winding for the dome part needs to be performed for several tens of cycles, and thus, if, in each of such cycles, winding is performed so as to involve a shift from helical winding for the dome part to hoop winding for the cylindrical part, the thickness of the cylindrical part will be increased by more than necessary. Meanwhile, if, only in part of such cycles, winding is performed so as to involve such shift from helical winding to hoop winding, variations will occur in the amount of winding in the circumferential direction, leading to the generation of stress concentrations.

In view of the above, in the present embodiment, as to the liner 20 (see FIGS. 2 and 3) in which the outer diameter of the end of the cylindrical part 20a is smaller than the outer diameter of the portion of the cylindrical part 20a which excludes the end, a fiber bundle is helically wound around such liner 20 so as to follow a geodesic trajectory on the dome part 20b. In winding a fiber bundle so as to follow a geodesic line, the direction of fibers greatly deviates from the principal stress direction in the cylindrical part (in the case of a liner comprising a cylindrical part having a uniform outer diameter), as described above; however, in the present embodiment, the outer diameter of the liner 20 is varied such that the direction of fibers approaches the principal stress direction, whereby a large arrangement angle is achieved in the cylindrical part 20a. The arrangement angle in the cylindrical part 20a in the present embodiment will be described below in comparison with the arrangement angle in a conventional cylindrical part. It should be noted that a geodesic line refers to the shortest curve connecting two points on a curved surface, and, when winding a fiber bundle about the dome part 10b, the slippage of fibers can be suppressed by winding such fiber bundle therearound so as to follow such geodesic line.

When a fiber bundle follows a geodesic trajectory located at a distance R₀ (see FIG. 3B) from the central axis AX of the high-pressure tank, an arrangement angle θ_{body} in the cylindrical part is defined by equation (1) below. It should be noted that R_{shoulder} in equation (1) below denotes a radius of the end (shoulder part) of the cylindrical part, as shown in FIG. 3A.

θ_{body}=sin⁻¹(R₀/R_{shoulder}) (1)

As to a comparative example, when, with a liner comprising a cylindrical part having a uniform outer diameter (the conventional liner 90 shown by the broken line in FIG. 3A), helically winding (symbol F2 shown in FIG. 3A) a fiber bundle around such liner so as to follow a geodesic trajectory located at the distance R₀ from the central axis AX of the high-pressure tank, the arrangement angle θ_{body} in the cylindrical part results in θ_{body}=33.7° (hereinafter referred to as θ₂) based on equation (1) with R₀=50 and R_{shoulder}=90. One helical layer with θ₂=33.7 corresponds to approximately 0.1 hoop layers based on the correlation graph shown in FIG. 4 (the graph showing the correlation between an arrangement angle and a value of conversion to hoop layers (in terms of the number of layers)).

In contrast to this comparative example, in the case of using, as in the present embodiment, the liner 20 in which the end of the cylindrical parts 20a has a reduced outer diameter, i.e., in the case of using the liner 20, as in FIG. 3A, with a radius R_{shoulder}=80 of the end of the cylindrical part 20a and a radius R′_{body}=90 of the portion of the cylindrical part 20a which excludes the end, the arrangement angle θ_{body} in the cylindrical part 20a is large. More specifically, as to helical winding for the dome part 20b, when helically winding a fiber bundle (symbol F1 shown in FIG. 3A) around the liner 20 so as to follow the geodesic trajectory located at the distance R₀=50 from the central axis AX of the high-pressure tank, the arrangement angle θ_{body} in the cylindrical part 20a results in θ_{body}=38.7° (hereinafter referred to as θ₁) from equation (1). One helical layer with θ₁=38.7° corresponds to approximately 0.2 hoop layers based on the correlation graph shown in FIG. 4 (the graph showing the correlation between an arrangement angle and a value of conversion to hoop layers (in terms of the number of layers)).

As indicated by the values of θ₂ and θ₁, the helical winding angle θ₁ in the cylindrical part 20a in the present embodiment, at which, when performing helical winding for the dome part 20b, the fiber bundle is wound around the liner 20 at the distance R₀ from the central axis AX of the high-pressure tank, is made larger than the helical winding angle θ₂, at which, as to the liner 90 comprising a cylindrical part having a uniform outer diameter, the fiber bundle is wound around the liner 90 at the distance R₀.

As described above, by increasing the helical winding angle in the cylindrical part 20a, the value of conversion to hoop layers (in terms of the number of hoop layers) in the cylindrical part 20a is increased accordingly. With such increase in the value in terms of the number of hoop layers, the direction of fibers in helical winding in the cylindrical part 20a approaches the principal stress direction, whereby the strength of the cylindrical part 20a can be improved.

The principal stress direction (the broken line S shown in FIG. 3A) in the present embodiment refers to the direction of a principal stress from among various stresses applied to the liner. This principal stress direction S varies in accordance with the liner shape. However, in the case of a general, substantially cylindrical liner shape, the principal stress direction exists within a range of from +45° to +60° relative to the axial direction.

FIGS. 3A and 3B show the liner 20 in which the outer diameter of the end (shoulder part) of the cylindrical part 20a is smaller than the outer diameter of the portion of the cylindrical part 20a which excludes the end. However, the applicable liner is not limited to such example, and a “fiber-bundle wound liner” may also be employed. That is, according to the present embodiment, as to a fiber-bundle wound liner in which an outer diameter of an end of a cylindrical part is smaller than an outer diameter of a portion of the cylindrical part which excludes the end, a fiber bundle may be helically wound around such liner so as to follow a geodesic trajectory on a dome part thereof.

The embodiments of the present invention have been described above with reference to specific examples. However, the present invention is not limited to such specific examples. That is, such specific examples additionally involving appropriate design changes by a person skilled in the art may also be encompassed by the present invention, as long as they comprise the features of the present invention. The elements comprised in the above-stated specific examples and the relevant arrangements, materials, conditions, shapes, sizes, etc., may not be limited to the ones illustrated herein and may be changed appropriately.

### DESCRIPTION OF SYMBOLS

10: high-pressure tank
10a: body part
10b: hemispherical part
14: mouthpiece
14a: opening
20: liner
20a: cylindrical part
20b: dome part
21: outer peripheral surface
30: reinforcing layer
C1: connecting part (entrance-to-dome part)
C2: stepped part

What is claimed is:

1. A high-pressure tank comprising: a liner; and a reinforcing layer of fiber bundles would around the liner, wherein:
the liner comprises a cylindrically-shaped cylindrical part and a hem ispherically-shaped dome part which is continuous with an end of the cylindrical part;
the reinforcing layer includes a fiber bundle which is hoop-wound around the cylindrical part of the liner and a fiber bundle which is helically wound around the dome part thereof; and
an outer diameter of the end is smaller than an outer diameter of a portion of the cylindrical part which excludes the end.

2. The high-pressure tank according to claim 1, wherein the end has a tapered part whose outer diameter decreases from an axial center of the cylindrical part toward the dome part.

3. The high-pressure tank according to claim 2, wherein the tapered part has an inclination angle of from 5 to 10° relative to an axial center line of the cylindrical part.

4. A method of manufacturing a high-pressure tank comprising a liner, being an inner shell, which has a cylindrically-shaped cylindrical part and a hem ispherically-shaped dome part which is continuous with an end of the cylindrical part,
wherein, as to a liner or a fiber-bundle wound liner in which an outer diameter of the end is smaller than an outer diameter of a portion of the cylindrical part which excludes the end, a fiber bundle is helically wound around the liner so as to follow a geodesic trajectory on the dome part.
